(19) United States
(12) Patent Application Publication
(10) Pub. No.: US 2012/0163931 A1
(43) Pub. Date: Jun. 28, 2012

(54) TOOL

(76) Inventor: Arno Friedrichs, Kulmbach (DE)

(21) Appl. No.: 13/389,917

(22) PCT Filed: Jun. 21, 2010
(86) PCT No.: PCT/EP2010/058693

§ 371 Date: Mar. 5, 2012

(30) Foreign Application Priority Data
Aug. 25, 2009 (DE) 10 2009 043 850.5

(51) Int. Cl. B23B 51/06; B23C 5/28

(52) U.S. Cl. 408/57; 407/11

(57) ABSTRACT

The invention relates to a tool which comprises a shank with a central, continuous internal channel and an insert which protrudes into the internal channel and is frictionally and/or mechanically positively connected with the shank, wherein the internal channel has one or more widenings which in work operation of the tool serve as cooling channels.

The invention relates to a tool comprising a shank with a centrally arranged, continuous internal channel and an insert protruding into the internal channel and frictionally and/or mechanically positively connected with the shank.

Drilling tools of one-part construction are already known, which comprise a shank and one or more internal channels which extend rectilinearly or helically in the interior of the shank and serve as cooling channels. In the case of drilling tools of that kind cooling liquid is during working operation forced through the cooling channels in the direction of the tool head in order to cool the working region of the drilling tool.

The object of the invention consists in indicating a new tool in which the cooling during working operation is improved,

This object is fulfilled by a tool with the features indicated in claim 1. A tool according to the invention comprises a shank with a central, continuous internal channel and an insert protruding into the internal channel and frictionally and/or mechanically positively connected with the shank, wherein the internal channel is provided with one or more widenings. Advantageous embodiments and developments of the invention are indicated in the dependent claims.

The advantages of the invention consist particularly in that during working operation of the tool a cooling liquid can be forced from the rear end of the shank through the internal channel and the widenings of the internal channel in the direction of the working surface of the tool. This cooling liquid issues at the front end of the shank from the widenings surrounding the insert, flows along the outer circumference of the insert in the direction of the working region of the tool and cools this in desired manner. The said widenings can be formed in simple manner within the scope of production of the shank. This preferably takes place at the time of production of a blank by means of an extrusion process and/or with use of a broaching tool, by way of which starting from an initially cylindrical internal channel the widenings of the internal channel can be formed, or by means of electro-eroding.

The shank and the insert are preferably of cylindrical construction, wherein the diameter of the shank is greater than the diameter of the insert.

The insert can be glued, soldered, shrink-fitted or screw-connected with the shank. The shank can consist of the same material as the insert or of a different material. The shank preferably consists of steel, hard metal, ceramic or synthetic material and the insert of steel, hard metal or ceramic,

The widenings are preferably formed to be partly circular, rectangular or triangular. The number of widenings is preferably 1, 2, 3, 4 or 5.

The tool is preferably a drilling tool or a milling tool, particularly for use in the micro-drilling field or in dentistry.

The widenings of the insert preferably form rectilinearly or helically surrounding channels. They can extend over the entire length of the internal channel or, however, only over a part of the entire length of the internal channel.

Further advantageous characteristics of the invention are evident from the following exemplifying explanation by way of the figures, in which:

FIG. 1 shows a sketch of a longitudinal sectional illustration of a tool according to a first exemplifying embodiment for the invention,

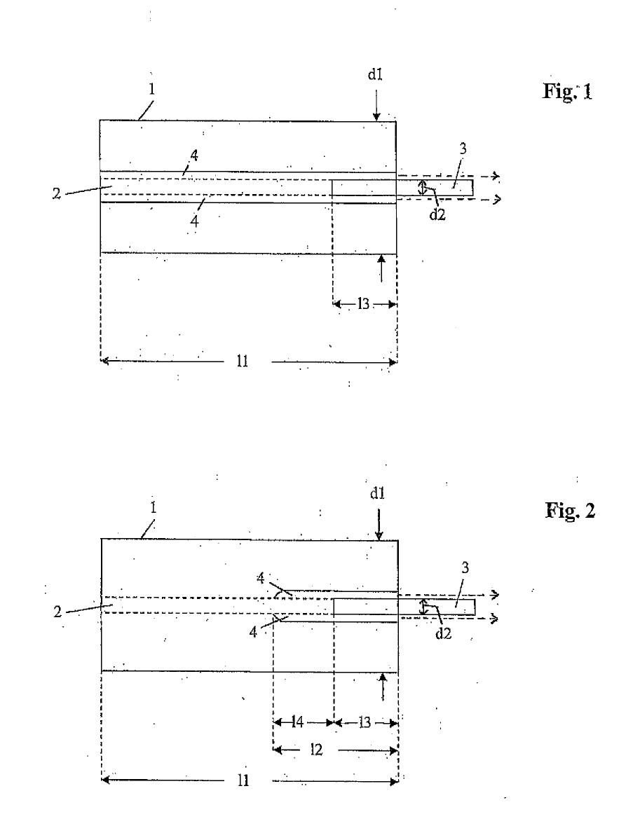

FIG. 2 shows a sketch of a longitudinal sectional illustration of a tool according to a second exemplifying embodiment for the invention,

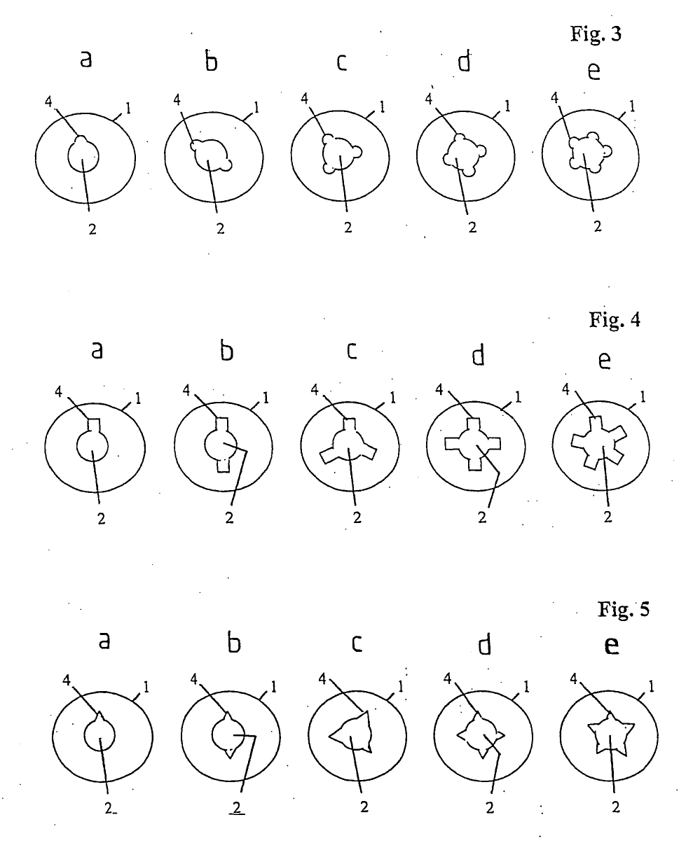

FIG. 3 shows cross-sectional illustrations for explanation of tools with partly circular widenings of the internal channel,

FIG. 4 shows cross-sectional illustrations for explanation of tools with partly rectangular widenings of the internal channel,

FIG. 5 shows cross-sectional illustrations for explanation of tools with partly triangular widenings of the internal channel and

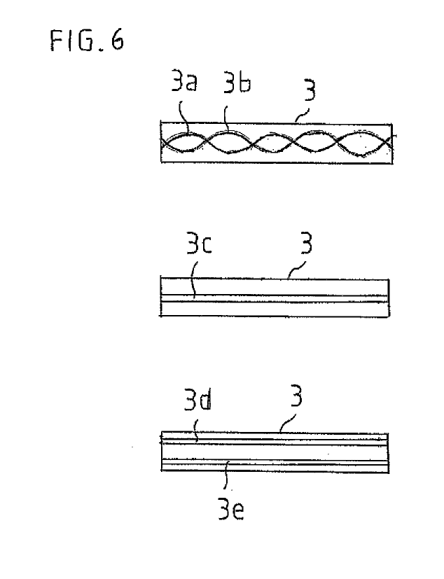

FIG. 6 shows sketches of exemplifying embodiments for inserts furnished with internal channels.

FIG. 1 shows a sketch of a longitudinal sectional illustration of a tool according to a first exemplifying embodiment for the invention. The tool illustrated in FIG. 1 is a drilling tool which is provided for use in the micro-drilling field or in dental technology.

This drilling tool comprises a shank 1, a continuous internal channel 2 centrally arranged within the shank 1, an insert 3 protruding into the internal channel 2 and connected in force-locking and/or shape-locking manner with the shank 1, and one or more widenings 4 of the internal channel 2.

The overall length of the shank 1 and thus also of the internal channel 2 is 11. The widenings 4 extend rectilinearly and run over the entire length of the shank 1. The length of the widenings 4 is consequently similarly 11. The part of the total length of the internal channel 2 in which the shank 1 is connected with the insert 3 is denoted in FIG. 1 by 13. The diameter of the shank 1 is denoted by dl. It is apparent from FIG. 1 that the diameter dl of the shank 1 is greater than the diameter d2 of the insert 3.

During working operation of the drilling tool cooling liquid under pressure is introduced into the internal channel of the shank 1 at the rear end of the shank 1, which in FIG. 1 is the lefthand end of the shank 1. This cooling liquid flows in the region, which is denoted by 13, of the shank through the widenings 4 and is issued at the front end of the shank 1, which in FIG. 1 is the righthand end of the shank 1, under pressure through the widenings 4. From there the cooling liquid flows out, as is indicated in FIG. 1 by arrows, along the outer circumference of the insert 3 in the direction of the righthand end of the insert 3 at which the working region of the tool, i.e. the cutter, is located. The working region of the tool 1 is thereby cooled in desired manner in working operation of the tool.

The internal channel 2 and the widenings 4 are preferably formed within the scope of production of the shank 1 by an extrusion process in a tool blank. Alternatively thereto the internal channel 2 and the widenings 4 can also be formed in a tool blank by means of a broaching tool or be produced by electro-erosion. After formation of the internal channel 2 and the widenings 4 the blank is further processed to form the finished shank. Thereafter, the insert 3 is introduced into the shank 1 and mechanically positively and/or frictionally connected with the shank 1, for example by soldering, gluing, shrink-fitting or screw-connecting. The cutter disposed at the front end of the insert can be made before or after fastening of the insert in the shank.

FIG. 2 shows a sketch of a longitudinal illustration of a tool according to a second exemplifying embodiment for the invention.

The tool illustrated in FIG. 2 is also a drilling tool which is provided for use in the micro-drilling field or in dental technology.

The tool shown in FIG. 2 substantially corresponds with the tool shown in FIG. 1. In the following merely the differences from tool shown in FIG. 1 are explained,

In the case of the tool shown in FIG. 2 the widenings 4 extend not over the entire length 11 of the internal channel 2, but only over a part region 12 of the total length of the internal channel. This part 12 comprises the part 13 of the total length of the internal channel 2 in which the shank 1 is connected with the insert 3 and a part 14 which is connected therewith, of the total length of the internal channel 2.

In this exemplifying embodiment initially the internal channel 2 of the shank 1 is formed by an extrusion tool or by means of a broaching tool in a blank. Thereafter, formation of the widenings 4 is carried out by means of a broaching tool in order to form a blank having the desired form. This is then further processed to the desired end product, namely into a shank.

The insert 3 is then introduced into this shank just as in the case of the exemplifying embodiment shown in FIG. 1 and mechanically positively and/or frictionally connected with the shank 1.

FIG. 3 shows in total five cross-sectional illustrations for explanation of tools which have partly circular widenings of the internal channel 2. The tool shown in FIG. 3a comprises a shank 1 in which a centrally arranged internal channel 2 is provided, wherein the internal channel 2 has one partly circular widening 4. The tool shown in FIG. 3b comprises a shank 1 in which a centrally arranged internal channel 2 is provided, wherein the internal channel 2 has two partly circular widenings 4. The tool shown in FIG. 3c comprises a shank 1 in which a centrally arranged internal channel 2 is provided, wherein the internal channel 2 has three partly circular widenings 4. The tool shown in FIG. 3d comprises a shank 1 in which a centrally arranged internal channel 2 is provided, wherein the internal channel 2 has four partly circular widenings 4. The tool shown in FIG. 3e comprises a shank 1 in which a centrally arranged internal channel 2 is provided, wherein the internal channel 2 has five partly circular widenings 4. Those edge regions of the internal recess 2 of the shank 1 at which no widenings 4 are provided serve for mechanically positive and/or frictional connection of the shank with the insert.

FIG. 4 shows in total five cross-sectional illustrations for explanation of tools having rectangular widenings of the internal channel 2. The tool shown in FIG. 4a comprises a shank 1 in which a centrally arranged internal channel 2 is provided, wherein the internal channel 2 has one rectangular widening 4. The tool shown in FIG. 4b comprises a shank 1 in which a centrally arranged internal channel 2 is provided, wherein the internal channel 2 has two rectangular widenings 4. The tool shown in FIG. 4c comprises a shank 1 in which a centrally arranged internal channel 2 is provided, wherein the internal channel 2 has three rectangular widenings 4. The tool shown in FIG. 4d comprises a shank 1 in which a centrally arranged internal channel 2 is provided, wherein the internal channel 2 has four rectangular widenings 4. The tool shown in FIG. 4e comprises a shank 1 in which a centrally arranged internal channel 2 is provided, wherein the internal channel 2 has five rectangular widenings 4. Those edge regions of the internal recess 2 of the shank 1 at which no widenings 4 are provided serve for mechanically positive and/or frictional connection of the shank with the insert.

FIG. 5 shows in total five cross-sectional illustrations for explanation of tools having triangular widenings of the internal channel 2. The tool shown in FIG. 5a comprises a shank 1 in which a centrally arranged internal channel 2 is provided, wherein the internal channel 2 has one triangular widening 4. The tool shown in FIG. 5b comprises a shank 1 in which a centrally arranged internal channel 2 is provided, wherein the internal channel 2 has two triangular widenings 4. The tool shown in FIG. 5c comprises a shank 1 in which a centrally arranged Internal channel 2 is provided, wherein the internal channel 2 has three triangular widenings 4. The tool shown in FIG. 5d comprises a shank 1 in which a centrally arranged internal channel 2 is provided, wherein the internal channel 2 has four triangular widenings 4. The tool shown in FIG. 5e comprises a shank 1 in which a centrally arranged internal channel 2 is provided, wherein the internal channel 2 has five triangular widenings 4. Those edge regions of the internal recess 2 of the shank 1 at which no widenings 4 are provided serve for mechanically positive and/or frictional connection of the shank with the insert.

The exemplifying embodiments explained by way of the figures each concern, with respect to the tool, a drilling tool. Alternatively thereto, the tool can also be a milling tool.

The shank of the tool and the insert of the tool can consist of the same material or of different materials. The shank 1 preferably consists of steel, hard metal, ceramic or synthetic material and the insert 3 of steel, hard metal or ceramic.

The widenings 4 can be formed rectilinearly as in the case of the above exemplifying embodiments and extend in longitudinal direction of the cylindrical shank. Alternatively thereto, the widenings can helically surround the part of the insert 2 inserted into the shank 1.

According to an advantageous development of the invention it is also possible to provide in the insert 3 itself internal channels which in working operation of the respective tool serve as cooling channels and are flowed through by the respective coolant. These internal channels of the insert 3 can be helically extending or rectilinearly extending internal channels. Examples for internal channels of that kind at the insert 3 are shown in FIG. 6 and are denoted there by the reference numerals 3a, 3b, 3c, 3d and 3e.

1. Tool comprising a shank (1) with a central, continuous internal channel (2) and an insert (3) protruding into the internal channel and frictionally and/or mechanically positively connected with the shank, wherein the internal channel (2) has one or more widenings (4).

2. Tool according to claim 1, wherein the shank (1) is of cylindrical construction and has a larger diameter (d1) than the insert (3).

3. Tool according to claim 1, wherein the insert (3) is of cylindrical construction and has a smaller diameter (d2) than the shank (1).

4. Tool according to any one o claim 1, wherein the insert (3) is glued, soldered, shrink-fitted or screw-connected with the shank (1).

5. Tool according to claim 1, wherein the widenings (4) are formed to be part-circular, rectangular or triangular.

6. Tool according to claim 1, wherein it has one, two, three, four or five widenings (4).

7. Tool according to claim 1, wherein it is a drilling tool or a milling tool.

8. Tool according to claim 1, wherein the shank (1) consists steel, hard metal, ceramic or synthetic material.

9. Tool according to claim 1, wherein the insert (3) consists of steel, hard metal or ceramic.

10. Tool according to claim 1, wherein the widenings (4) form channels which rectilinearly or helically surround the insert (3).

11. Tool according to claim 1, wherein the widenings (4) extend over the entire length (1) of the internal channel (2).

12. Tool according to claim 1, wherein the widenings (4) extend over only a part (12) of the total length of the internal channel (2), wherein this part (12) comprises the part (13) of the total length of the internal channel (2) in which the shank (1) is connected with the insert (3) as well as a part (14), which is connected therewith, of the total length of the internal channel (2).

13. Tool according to claim 1, wherein the insert (3) has internal channels.
